(19) United States
(12) Patent Application Publication
(10) Pub. No.: US 2015/0152811 A1
(43) Pub. Date: Jun. 4, 2015

(54) FLAP DRIVING DEVICE IN PARTICULAR FOR AN ADAPTIVE NOZZLE

(71) Applicant: AIRCELLE, GONFREVILLE L'ORCHER (FR)

(72) Inventors: Olivier KERBLER, ANTONY (FR); Olivier GILO, VERSAILLES (FR); Pierre CARUEL, LE HAVRE (FR)

(21) Appl. No.: 14/597,352

(22) Filed: Jan. 15, 2015

Related U.S. Application Data
(63) Continuation of application No. PCT/FR2013/051777, filed on Jul. 23, 2013.

(30) Foreign Application Priority Data
Jul. 27, 2012 (FR) 12/57334

(51) Int. Cl. F02K 1/76; F02K 1/12; B64D 33/04

(52) U.S. Cl. CPC F02K 1/763; B64D 33/04; F02K 1/1207

(57) ABSTRACT

A device is provided to drive flaps for an adaptive nozzle of a nacelle, and the adaptive nozzle includes at least one flap moveable in rotation and adapted to pivot toward a position causing a variation of a nozzle section. In particular, the device includes a control ring and a connecting rod driving the flaps. The control ring rotates along a circumference of the nacelle during a driving rod drives the control ring, and the connecting rod is connected to the control ring and one of the flaps so that the driving rod causes a displacement in translation of the connecting rod. The driving rod is connected to an assembly forming a lever, and the assembly is secured to the control ring.

### CROSS-REFERENCE TO RELATED APPLICATIONS

This application is a continuation of International Application No. PCT/FR2013/051777, filed on Jul. 23, 2013, which claims the benefit of FR 12/57334, filed on Jul. 27, 2012. The disclosures of the above applications are incorporated herein by reference.

### FIELD

The present disclosure relates to a device for driving flaps in particular for an adaptive nozzle of nacelle of turbojet engine of aircraft.

### BACKGROUND

The statements in this section merely provide background information related to the present disclosure and may not constitute prior art.

An aircraft is moved by several turbojet engines each housed in a nacelle. The nacelle generally has a tubular structure comprising an air inlet upstream of the turbojet engine, a median section intended to surround a fan of turbojet engine, a downstream section accommodating the thrust reversal means and intended to surround the combustion chamber of the turbojet engine and, generally terminated by an ejection nozzle located downstream of the turbojet engine.

This nacelle is intended to house a double flow turbojet engine able to generate by means of the blades of the fan in rotation a hot air flow, from the combustion chamber of the turbojet engine, and a cold air flow which circulates outside the turbojet engine through an annular channel called stream.

The thrust reversal device is, during the landing of the aircraft, intended to improve the braking capacity of the latter by redirecting towards the front at least part of the thrust generated by the turbojet engine.

In this phase, the thrust reversal device obstructs the stream of cold air flow and directs the latter towards the front of the nacelle, thereby generating a counter-thrust which is added to the braking of the wheels of the aircraft, the means implemented for achieving this reorientation of the cold air flow vary according to the type of reverser.

The means implemented for achieving this reorientation of the cold flow vary according to the type of reverser. However, the structure of a reverser generally comprises moveable cowls displaceable between, on the one hand, a deployed position in which they open in the nacelle a passage intended for the diverted flow, and on the other hand, a retractable position in which they close this passage. These cowls may fulfill a diverting function or simply an activation one of other diverting means.

Furthermore, apart from its thrust reversal function, the reverser cowl belongs to the rear section of the nacelle and has a downstream part forming the ejection nozzle aiming to channel the ejection of the air flows.

The optimal section of the ejection nozzle may be adapted according to the different phases of the flight, namely the take-off, climb, cruise, descent and landing phases of the airplane. The already well known advantages of such adaptive nozzles are in particular the noise reduction or the fuel consumption decrease.

The variation of this section, illustrating the variation of the section of the cold air flow stream, may be carried out by a partial translation of the reverser cowl.

The variation of the outlet section of the cold air flow stream may also be achieved thanks to a plurality of flaps, still called deflectors, moveably mounted in rotation at a downstream end of the cowl, and adapted to pivot between a retracted position in which they are in the continuity of the aerodynamical line of the secondary air flow stream, a deployed position causing a section variation of the nozzle, and a plurality of positions intermediary with respect to said retracted and deployed positions.

It is known from the prior art to connect each of the flaps to a drive ring, located on the circumference of the nacelle, by a connecting rod system. The ring is moveable in rotation around the longitudinal axis of the nacelle, and the putting into rotation of the ring drives the rotation and synchronizing of the panels of the nozzle thanks to the connecting rod systems.

It may be cited by way of example the prior art document US 2008/0000235, which describes such a device for driving in rotation the rotary flaps of the adaptive nozzle.

According to this document of the prior art, the control ring comprises several guide slots inside which is inserted a guide pin secured to a flap. The rotation of the ring drives into translation the guide pin into the guiding slot and simultaneously into rotation of each flap.

A drawback pertaining to this type of driving is that the guide pin works by flexion, thus able to create fatigue at the guide pin, able in time to cause the rupture of this pin and the wrenching of the flaps.

### SUMMARY

The present disclosure provides a device for driving flaps in particular for an adaptive nozzle of nacelle of turbojet engine of an aircraft, said nozzle comprising at least one flap moveable in rotation and adapted to pivot at least towards a position causing a variation of the nozzle section, said device comprising at least one control ring moveable in rotation along the circumference of said nacelle during the activation of driving means for driving the control ring, said device for driving flaps comprising at least one connecting rod for driving the flap and connected on the one hand directly or indirectly to said control ring and on the other hand directly or indirectly to at least one flap, the activation of said driving means for driving the control ring causing a displacement in translation of said connecting rods, said device being characterized in that the driving means for driving the control ring comprise at least one longitudinal drive cylinder comprising at least one cylinder rod connected to at least one assembly forming lever, said at least one assembly forming lever being directly or indirectly secured to said ring.

Thus, by providing a control ring driven in rotation by means of an assembly forming lever, the forces subjected by the cylinder rod of the cylinder during the driving in rotation of said ring are substantially reduced.

Moreover, the assembly forming lever allows increasing the precision of displacement of the drive connecting rod, thus allowing to adapt in a particularly precise manner the outlet section of the ejection nozzle according to the flight phases in which the aircraft is.

According to other features of the present disclosure:

the assembly forming lever is connected to the control ring by means of at least one carriage shaped to translate in an oblong hole of said control ring;

at least one connecting rod for driving the flaps is connected to at least one of said assemblies forming lever;

at least one of said assemblies forming lever is an L-shaped assembly;

at least one of said assemblies forming lever is a T-shaped assembly;

the connection between said cylinder rod of longitudinal drive cylinder and said assembly forming lever is a sliding connection;

the connection between said cylinder rod of longitudinal drive cylinder and said assembly forming lever is a pivot connection of vertical axis;

the connection between said connecting rod for driving the flap and said assembly forming lever is a sliding connection;

the connection between said connecting rod for driving the flap and said assembly forming lever is a pivot connection of vertical axis;

the cylinder rod of longitudinal drive cylinder may be connected to the assembly forming lever by means of at least one carriage;

the connecting rod for driving the flap may be connected to the assembly forming lever by means of at least one carriage;

the control ring extends substantially over the totality of the circumference of the nacelle;

the control ring comprises a plurality of independent sections moveable in rotation along the circumference of said nacelle during the activation of the drive means.

The present disclosure also relates to a thrust reverser for nacelle of turbojet engine of aircraft comprising at least one downstream cowl comprising in its downstream part at least one adaptive nozzle comprising at least one flap alternatively moveable between at least one retracted position and a deployed position, characterized in that said cowl comprises at least one device for driving the flaps of said nozzle according to the present disclosure.

Finally, the present disclosure relates to a nacelle of turbojet engine of aircraft comprising at least one thrust reverser according to the present disclosure.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 represents a nacelle for turbojet engine equipped with an adaptive nozzle with rotary flaps activated thanks to the drive device according to the present disclosure;

FIG. 2 defines the trihedral (L, T, V);

FIG. 3 illustrates a first form of the drive device according to the present disclosure;

FIGS. 4a to 4c illustrate in top view the drive device according to the first form in neutral, advanced and receded positions;

FIG. 5 is a top view of part of the control ring connected to the drive connecting rod by a carriage;

FIG. 6 illustrates a second form of the drive device according to the present disclosure;

FIGS. 7a to 7c illustrate in top view the drive device according to the second form in the neutral, advanced and receded positions;

FIG. 8 illustrates another form of the driving in rotation of the ring;

FIGS. 9 to 11 respectively correspond to FIGS. 6 to 8, the drive device being achieved according to a first example of a third form;

FIGS. 12 to 14 respectively correspond to FIGS. 9 to 11, the drive device being achieved according to a second example of the third form;

FIG. 15 represents a common feature to the two examples of the third form; and

FIG. 16 illustrates an example of connection between the drive connecting rod and a flap.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Furthermore, the terms “upstream” and “downstream” are employed in the description, with reference to the flow direction of the air in the nacelle, the upstream of the nacelle corresponding to an air inlet area whereas the downstream corresponds to an air exhaust area.

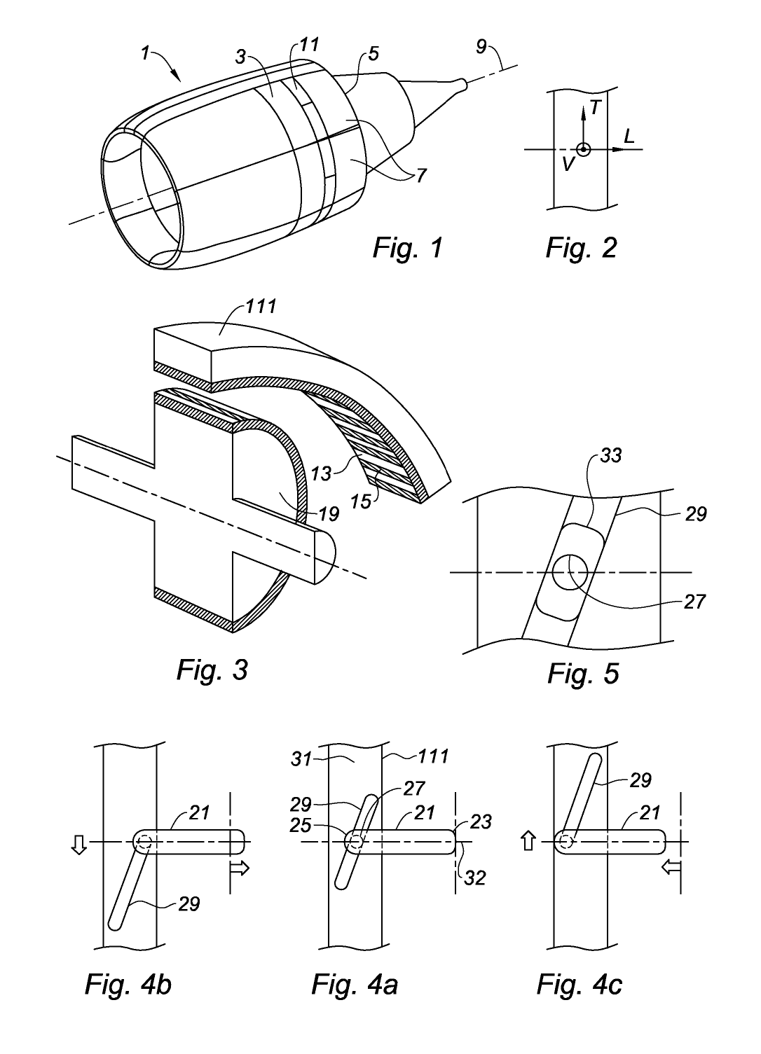

It is referred to FIG. 1, schematically representing a nacelle 1 comprising a cowl 3 of thrust reverser equipped in its downstream part with a nozzle 5 for ejecting the secondary air flow.

The nozzle 5 is adaptive, that is to say that the section of the ejection nozzle may be adapted according to the different phases of flight in order to make the section of secondary air flow stream vary.

The variation in section of the ejection nozzle is achieved thanks to a plurality of flaps 7, still called deflectors, moveable in rotation around a substantially transverse axis to the longitudinal axis 9 of said nacelle 1.

These flaps are connected to a control ring 11 mounted on the periphery of the nacelle 1.

In the present disclosure, and as represented on FIG. 2 partially illustrating the control ring 11 in top view, the term “longitudinal” represents any axis collinear to the longitudinal axis L of the nacelle, whereas the term “transversal” represents any axis collinear to the axis T tangent to the control ring. Finally, the term “vertical” is meant as any axis collinear to the axis V forming the direct trihedral (L, T, V).

The device for driving flaps according to the present disclosure comprises a control ring achieved according to the different forms which will be described, moveable in rotation around the longitudinal axis of the nacelle, driving means for driving said ring, and at least one connecting rod for driving nozzle flaps.

In the present disclosure, it is meant by control ring a ring of substantially annular form, substantially extending over the totality of the circumference of the nacelle.

It is referred to in FIG. 3, illustrating the driving means for driving a control ring 111 achieved according to a first form.

The control ring 111 has an inner face 13 comprising gear teeth 15 shaped to engage gear teeth 17 of a pinion 19 driven in rotation thanks to a motor, for example electric, not represented.

The control ring 111 is notched on the totality of the inner face 13 or, alternatively, on one or several portions of said inner face.

FIGS. 4a to 4c illustrate the control ring 111 represented partially, in top view.

The control ring 111 is connected to a drive connecting rod 21 of which an end 23 is connected to the flap (not represented) of the nozzle.

The drive connecting rod 21 is secured at its end 25 by a vertical guiding pin 27 shaped to be translated in a guiding slot 29 achieved on the outer face 31 of the control ring 111.

The outer face represents the face of the ring farthest from the longitudinal axis of the nacelle, whereas the inner face is the face of the ring nearest to said longitudinal axis. Lateral walls transversal to the longitudinal axis of the nacelle connect said inner and outer faces of the ring.

According to one form not represented on the figures, the guiding slot may be achieved on the inner face of the control ring 111, or may even radially cross said ring.

The guiding slot 29 is oblique and allows a displacement of the connecting rod 21 to a position called “advanced” represented on FIG. 4b, a position obtained when the control ring is driven clockwise in rotation when the ring is viewed from the upstream of the nacelle to the downstream. The guiding slot also allows a displacement in a position called “receded” of the connecting rod 21, a position obtained for an anticlockwise rotation of the ring when the ring is viewed from the upstream of the nacelle to the downstream, and represented on FIG. 4c.

For a position called “neutral” represented on FIG. 4a, the longitudinal axis 32 of the drive connecting rod 21 is substantially in the middle of the guiding slot 29.

However, when the required amplitude of the displacement of the connecting rod in advanced position is distinct from the required amplitude of the displacement of the connecting rod in receded position, the longitudinal axis of the connecting rod in neutral position is obviously no longer in the middle of the guiding slot, but shifted in the vicinity of one or the other of the ends of the guiding slot.

In another form, as represented on FIG. 5, the guiding pin 27 is secured to a moveable carriage 33 translating in the guiding slot 29. Typically, the connection between the guiding pin 27 and the guiding slot may be modeled by a “plane-plane” and “cylinder-cylinder” type connection, thus preventing to have a punctual contact between the guiding pin and the guiding slot.

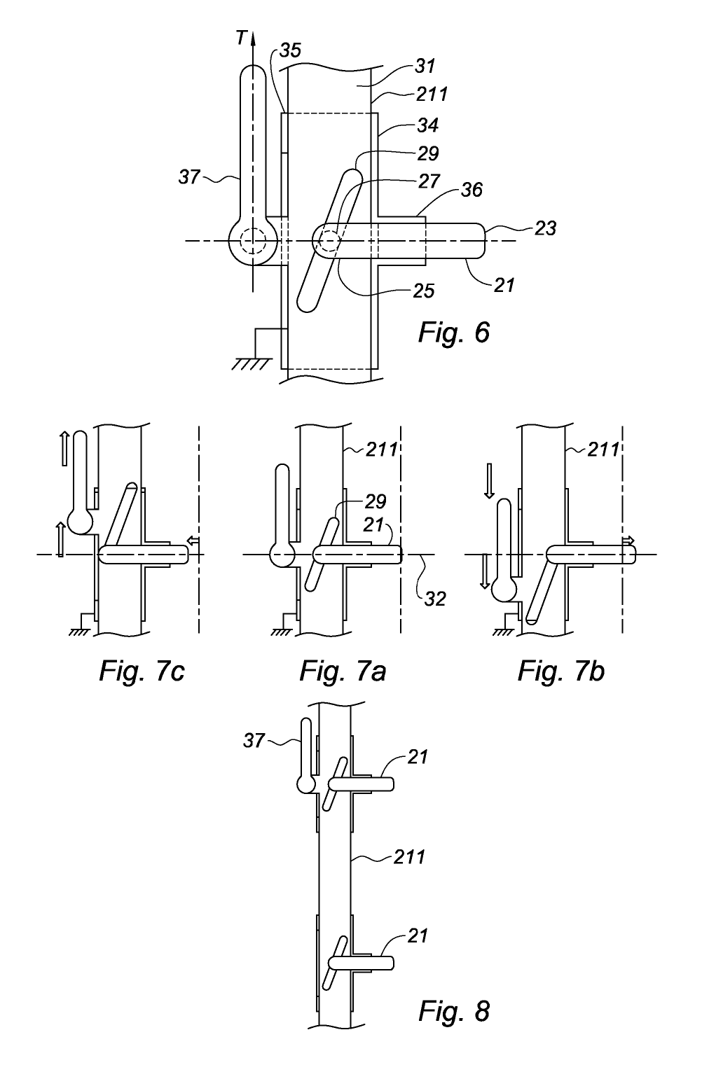

It is now referred to FIGS. 6 to 8, representing a second form of the device for driving flaps according to the present disclosure.

In this form of the present disclosure, the control ring 211 is similar to the control ring 111 described in reference to the first form with the exception that the inner face no longer has teeth.

The control ring 211 is mounted on a plurality of stationary rails 34 (a single rail 34 is visible on FIG. 6) and secured to the nacelle. By way of example, there are as many rails as drive connecting rods connected to the control ring.

Typically, a rail 34 adopts a T shape and has an opening 35 shaped to allow the passage of the control ring 211, and is terminated by a plate 36 shaped to allow the displacement of the drive connecting rod 21. There are as many rails 34 as connecting rods 21 for driving flaps.

In one form, the control ring is mounted on a single guiding rail (not represented) comprising a circumferential circle secured to the nacelle and having a plurality of plates all secured to the circumferential circle and each allowing the displacement of the corresponding drive connecting rod.

The driving means for driving the ring 211 comprise a transversal drive cylinder, comprising a transversal cylinder rod 37, secured to said ring.

In another form, the cylinder rod 37 has an angle ranging between +/−45° with respect to the transversal axis T.

The control ring 211 is connected to the drive connecting rod 21 of which the end 23 is connected to the flap (not represented) of the nozzle.

The drive connecting rod 21 is secured at its end 25 to the vertical guiding pin 27 translating in the guiding slot 29 achieved on the outer face 31 of the control ring 211.

As previously described, according to an example not represented on the figures, the guiding slot may be achieved on the inner face of the ring 211, or may even radially cross said ring.

It is referred to FIGS. 7a to 7c, illustrating the control ring 211 represented partially, in top view.

In the same manner as it has been described in reference to FIGS. 4a to 4c, the guiding slot 29 is oblique and allows a displacement of the connecting rod 21 to the advanced position such as represented on FIG. 7b, the position reached when the drive cylinder has been activated in such a manner as to allow the clockwise rotation of the control ring 211.

When the drive cylinder is activated in such a manner as to allow an anticlockwise rotation of the control ring 211, the connecting rod for driving flaps is in receded position as represented on FIG. 7c.

In neutral position, the longitudinal axis 32 of the drive connecting rod 21 is substantially in the middle of the guiding slot 29.

However, as previously described, when the required amplitude of the displacement of the connecting rod in advanced position is distinct from the required amplitude of the displacement of the connecting rod in receded position, the longitudinal axis of the connecting rod in neutral position is obviously no longer in the middle of the guiding slot, but shifted in the vicinity of one or the other of the ends of the guiding slot.

The control ring 211 may be put into rotation by the activation of a plurality of drive cylinders of which the end of each cylinder rod is secured to the ring and is substantially aligned with each drive connecting rod.

In one form according to the present disclosure, and as represented on FIG. 8, the control ring 211 is put into rotation by a single drive cylinder comprising a single cylinder rod 37. The activation of the drive cylinder causes the rotation of the control ring 211, thus driving in unison the displacement of all the flap drive connecting rods 21.

According to another form, the control ring is put into rotation by two drive cylinders of which the activation thereof causes the rotation of the control ring, driving in unison the displacement of all the drive connecting rods.

According to one form not represented and already explained in reference to FIG. 5, the guiding pin 27 may be secured to a moveable carriage 33 translating in the guiding slot 29, and the connection between the guiding pin 27 and the guiding slot may be modeled by a “plane-plane” and “cylinder-cylinder” type connection.

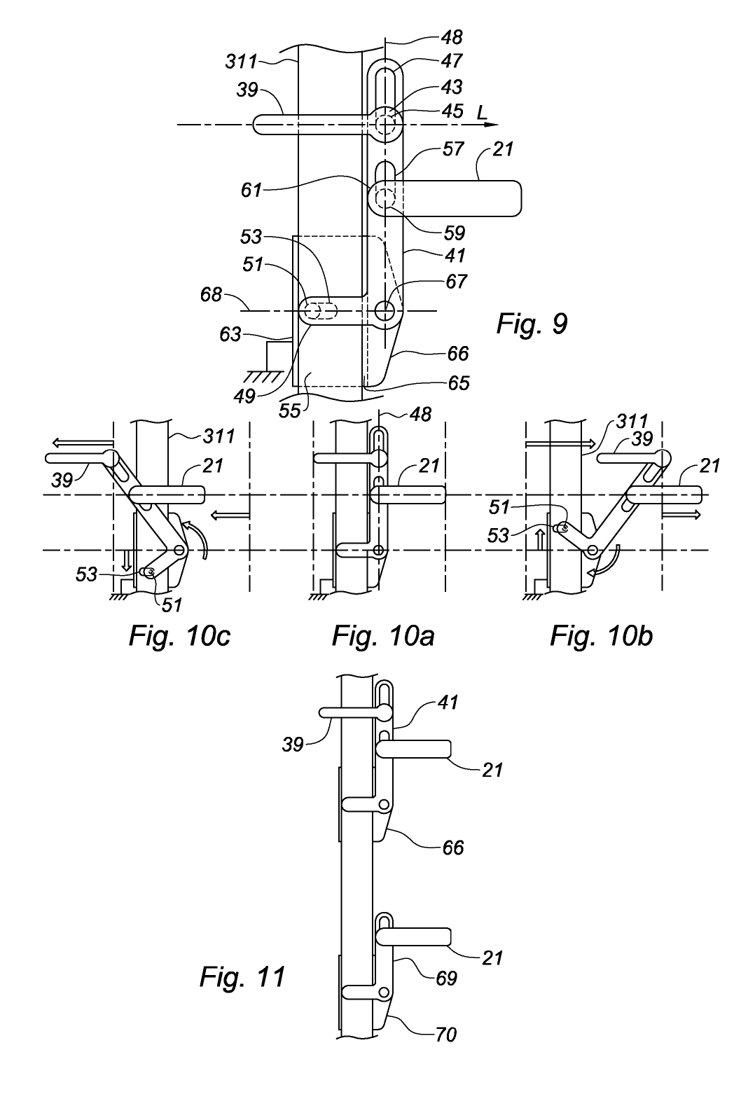

It is now referred to FIGS. 9 to 15, illustrating a third form device for driving flaps according to the present disclosure.

In this form of the present disclosure, the driving means for driving the control ring 311 comprise a longitudinal drive cylinder comprising a longitudinal cylinder rod 39 connected to said ring by an assembly forming lever 41.

According to a non-represented example, the cylinder rod 39 has an angle ranging between +/−45° with respect to the longitudinal axis L.

The cylinder rod 39 of the longitudinal drive cylinder is, in one form, connected to the extreme part of the assembly forming lever 41, thus allowing on the one hand to reduce the forces which apply on the cylinder rod of the cylinder and on the other hand allowing a displacement of the drive connecting rod with good precision.

However, it is obviously not excluded to swap the place of the drive connecting rod with the place of the cylinder rod if the skilled person finds it of interest.

The cylinder rod 39 is secured at its end 43 to a guiding pin 45 shaped to translate in a first oblong hole 47 of the assembly forming lever 41.

The mechanical connection between the guiding pin 45 and the oblong hole 47 may be modeled by a sliding connection having for direction a longitudinal axis 48 of the assembly forming lever 41.

According to a non-represented form, the guiding pin 45 is secured to a carriage translating in the oblong hole 47, resuming the principle of the example illustrated in reference on FIG. 5. The connection between the guiding pin 45 and the oblong hole 47 may thus be modeled by a “plane-plane” and “cylinder-cylinder” type connection.

The assembly forming lever 41 has an L shape of which an end 49 is secured to a guiding pin 51 shaped to translate in an oblong hole 53 inscribed on the outer face 55 of the control ring 311.

Such an assembly may adopt any other geometric shape provided that it allows multiplying the forces being exerted on the cylinder rod 39 of the drive cylinder.

The assembly forming lever 41 comprises a second oblong hole 57 shaped to receive a guiding pin 59 secured to an end 61 of the connecting rod 21 for driving the flap.

The mechanical connection between the guiding pin 59 and the oblong hole 57 may be modeled by a sliding connection having for direction the longitudinal axis 48 of the assembly forming lever 41.

As previously, according to a non-represented example, the guiding pin 59 may be secured to a carriage translating in the oblong hole 57 resuming the principle of the form illustrated in reference to FIG. 5. The connection between the guiding pin 59 and the oblong hole 57 may hence be modeled by a “plane-plane” and “cylinder-cylinder” type connection.

The control ring 311 is mounted on a plurality of stationary rails 63 (a single rail being represented on FIG. 9) and secured to the nacelle.

Typically, a rail 63 has an opening 65 provided for the passage of the control ring 311 and is terminated by a plate 66 supporting the assembly forming lever 41. There are as many rails 63 as connecting rods 21 for driving flaps.

In one form, the control ring is mounted on a single guiding rail (not represented) comprising a circumferential circle secured to the nacelle and having a plurality of plates all secured to the circumferential circle and each supporting an assembly forming lever.

The assembly forming lever 41 is connected to the plate 66 by a pivot connection of vertical axis 67 substantially positioned on a longitudinal axis 68 of the oblong hole 53 when said assembly is in a position corresponding to a neutral position of the drive connecting rod 21.

The cylinder rod 39 of the drive cylinder and the drive connecting rod 21 are on the same side of said axis 68.

It is referred to FIGS. 10a to 10c, illustrating the control ring 311 represented partially, in top view.

The FIG. 10a illustrates a neutral position of the drive connecting rod 21, a position according to which the axis 48 of the assembly forming lever 41 is substantially transversal.

The FIG. 10b illustrates an advanced position of the drive connecting rod 21.

This position is obtained for a displacement of the cylinder rod 39 of the longitudinal cylinder in a direction such that the assembly forming lever pivots in a clockwise manner, causing a translation of the guiding pin 51 of the assembly forming lever 41 in the oblong hole 53 of the control ring 311 in such a manner as to make said ring pivot in the anticlockwise direction.

The FIG. 10c illustrates a receded position of the drive connecting rod 21, a position obtained for a displacement of the cylinder rod 39 of the longitudinal cylinder in a direction such that the assembly forming lever pivots in the anticlockwise direction, causing a translation of the guiding pin 51 of the assembly forming lever 41 in the oblong hole 53 of the control ring 311 in such a manner as to make said ring pivot in the clockwise direction.

The control ring 311 may be put into rotation by activating a plurality of drive cylinders of which the end of each cylinder rod is secured to an assembly forming lever.

In one form, and as represented on FIG. 11, the control ring 311 is put into rotation by a single drive cylinder comprising a single cylinder rod 39. The activation of the single drive cylinder causes the rotation of the control ring 311 by the kinematic described in reference in FIGS. 10a to 10c, driving in unison the displacement of all the drive connecting rods 21. In this case, the control ring 311 comprises a single assembly forming lever 41 and a plurality of assemblies forming lever 69 distributed on the periphery of said ring and each connected on the one hand to a connecting rod for driving flaps and on the other hand to a plate 70 shaped to support the assembly forming lever 69.

In another form, the control ring is put into rotation by two drive cylinders of which the activation drives the rotation of the control ring, driving in unison the displacement of all the drive connecting rods.

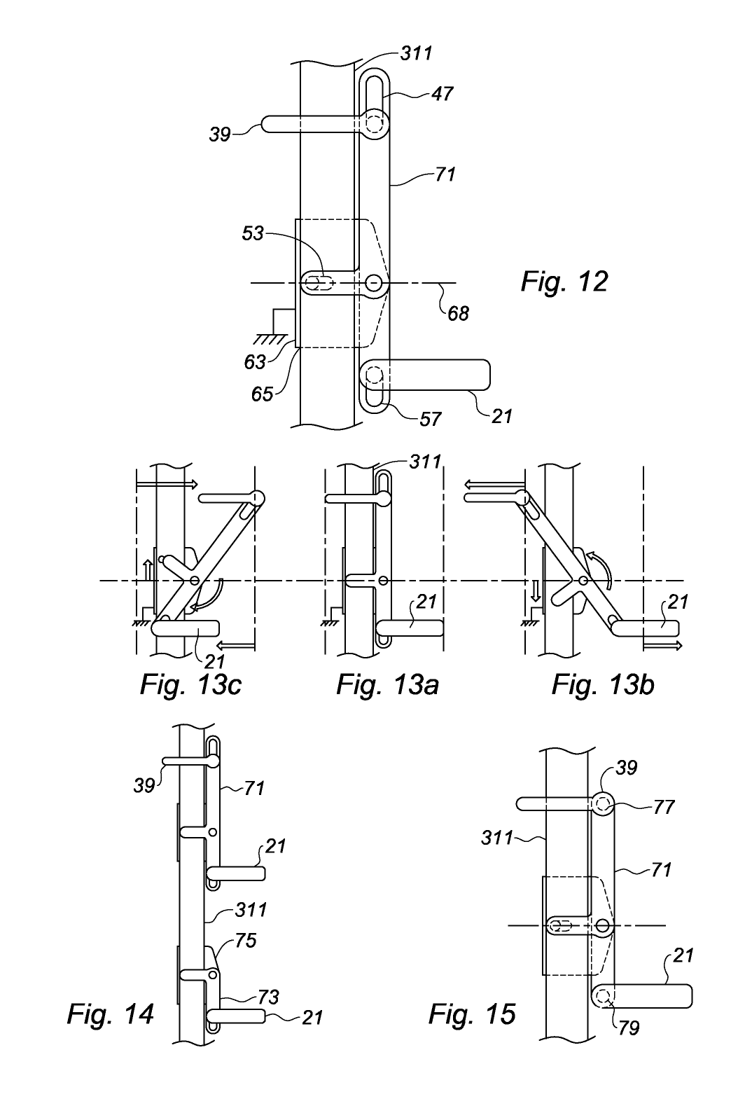

It is referred to FIGS. 12 to 14, illustrating a second form of the assembly forming lever.

According to this form, the control ring 311 is connected to an assembly forming lever 71 having a substantially T shape.

The assembly forming lever 71 is identical to the assembly forming lever 41 in an L shape with the exception that the oblong holes 47 and 57 respectively receiving the cylinder rod 39 of the drive cylinder and the drive connecting rod 21 are on either side of the longitudinal axis 68 of the oblong hole 53 when said assembly is in a position corresponding to the neutral position of the drive connecting rod 21.

As previously described, the control ring 311 is mounted onto a plurality of stationary rails 63 (a single rail being represented on FIG. 12) and secured to the nacelle, said rails 63 each having an opening 65 provided for the passage of said ring and terminating by a plate 66 shaped to support the assembly forming lever 71. There are as many rails as connecting rods 21 for driving flaps.

In one form, the control ring is mounted on a single guiding rail (not represented) comprising a circumferential circle secured to the nacelle and having a plurality of plates all secured to the circumferential circle and each supporting an assembly forming lever.

According to this second form, the kinematic of displacing the drive connecting rod 21 is inverted with respect to the first alternative, as FIGS. 13a to 13c illustrate.

By referring to these figures, the control ring 311 is put into rotation under the action of the cylinder rod 39 of the longitudinal cylinder. A clockwise rotation of the control ring 311 causes a displacement of the drive connecting rod 21 in an advanced position, and an anticlockwise rotation of said ring causes a displacement of said connecting rod in a receded position.

Furthermore, as for the first alternative of this third form, the control ring 311 may be put into rotation by the activation of a plurality of drive cylinders of which the end of each cylinder rod is secured to an assembly forming lever.

In another form, and as represented on FIG. 14, the control ring 311 is put into rotation by a single drive cylinder comprising a single cylinder rod 39, driving in unison the displacement of all the drive connecting rods 21. In this case, the control ring 311 comprises a single assembly forming lever 71 in a T shape and a plurality of assemblies forming lever 73 distributed on the periphery of said ring. Each of said assemblies forming lever 73 is connected, as described previously with reference to the assembly forming lever 69, on the one hand to a connecting rod for driving flaps and on the other hand to a plate 75 shaped to support said assembly forming lever 73.

In other form, the control ring is put into rotation by two drive cylinders of which the activation thereof causes the rotation of the control ring, driving in unison the displacement of all the drive connecting rods.

It is now referred to FIG. 15 illustrating one form of the assembly forming lever 71. According to this form, the oblong holes 47 and 57 are replaced by circular holes 77, 79 and the mechanical connections between the cylinder rod 39 of the drive cylinder and the assembly 71, and the drive connecting rod 21 and the assembly 71 may be modeled by a pivot connection of vertical axis.

Furthermore, this form applies to the oblong holes of the assembly forming lever 41, and also to each of the assemblies forming lever comprised by the control ring 311.

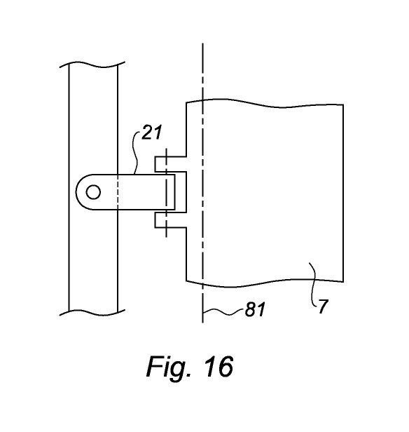

It is referred to FIG. 16, schematically illustrating a non-limiting example of connection between the drive connecting rod 21 and the flap 7 of the adaptive nozzle.

The translation of the connecting rod during the rotation of the control ring results in the creation of a moment allowing the pivoting of the flap 7 around the rotation axis 81 thereof.

The rotation axis of the flap may alternatively be positioned upstream or downstream of the position represented on FIG. 16.

According to another form, the flap 7 may be connected to the ring by means of two connecting rods placed on either side of said flap.

Furthermore, a plurality of connecting rods may connect the control ring to each flap.

Thanks to the present disclosure, the putting into rotation of a single peripheral ring allows simultaneously controlling and synchronizing a plurality of connecting rods for driving flaps.

According to the first form, the device for driving flaps is particularly adapted for nacelles with reduced master cross-section, for which the encumbrance must be reduced.

The device for driving flaps achieved according to the second and third forms is more particularly intended to be integrated to nacelles of larger size, owing to the presence of cylinders for driving the control ring in rotation.

Furthermore, the second and third forms advantageously allow substantially reducing the forces being exerted on the cylinder rod of the drive cylinder and on the connecting rod for driving flaps.

Furthermore, it must be well understood that the drive device according to the present disclosure applies to the adaptive nozzle flaps, but it is obviously not excluded to adapt this device for driving any other rotary moveable part of the nacelle, such as for example thrust reversal flaps, doors for thrust reverser with doors; etc.

Moreover, the description has been carried out with reference to a control ring of substantially annular shape, extending substantially over the totality of the nacelle circumference. Particularly, the control ring may just as well comprise a plurality of independent sections, each being controlled in rotation by at least one aforementioned drive means.

Finally, the present disclosure is not limited to the sole forms of this flap driving device, described above solely by way of illustrating example, but on the contrary encompasses all the alternatives.

To this end, it is worth noting that the drive device according to the present disclosure is not limited to the description which has been carried out and to the figures referring to it.

Particularly, and by way of example, it is represented on FIGS. 9 to 11 an L-shaped assembly forming lever 41, mounted downstream of the ring. It is possible to position this assembly forming lever not downstream of the ring but upstream, in a substantially symmetrical manner to the plane formed by the transversal and vertical axes. It is also possible to position the assembly forming lever 41 in a symmetrical manner with respect to the longitudinal axis 68 passing by the oblong hole 53 of the control ring.

In these cases, during a displacement of the connecting rod 39 of the cylinder from the upstream to the downstream of the nacelle, the displacement of the drive connecting rod 21 is inverted with respect to what has been described.

This disposition also applies to the T-shaped assembly forming lever 71 represented on FIGS. 12 to 15.

Finally, the guiding slot 29, provided on the control rings 111 and 211, is oblique, and extends, as represented on FIGS. 4a, 4b, 4c and 6 to 8, from the upstream to the downstream of the nacelle when the outer face of the ring is viewed. In another form, it is conceivable to extend the guiding slot from the downstream to the upstream of the nacelle when the outer face of the ring is viewed. The rotation direction is thus reversed, and a rotation in the clockwise direction of the ring causes a displacement of the drive connecting rod to a receded position.

What is claimed is:

1. A device for driving flaps for an adaptive nozzle of a nacelle of a turbojet engine of an aircraft, said adaptive nozzle comprising at least one flap moveable in rotation and adapted to pivot at least towards a position causing a variation of a nozzle section, said device comprising:
at least one control ring moveable in rotation along a circumference of said nacelle during activation of driving means configured to drive the control ring; and
at least one connecting rod driving the flaps, said connecting rod connected to said at least one control ring and at least one of the flaps, and the activation of said driving means causing a displacement in translation of said at least one connecting rod,
wherein said driving means comprise at least one longitudinal drive cylinder comprising at least one cylinder rod connected to at least one assembly forming a lever, and said at least one assembly is secured to said at least one control ring.

2. The device for driving flaps according to claim 1, wherein said at least one assembly is connected to said at least one control ring by at least one moveable carriage shaped to translate in an oblong hole of said control ring.

3. The device for driving flaps according to claim 1, wherein said at least one connecting rod is connected to said at least one assembly.

4. The device for driving flaps according to claim 1, wherein said at least one assembly is an L-shaped assembly.

5. The device for driving flaps according to claim 1, wherein said at least one assembly is a T-shaped assembly.

6. The device for driving flaps according to claim 1, wherein the connection between said at least one cylinder rod of the longitudinal drive cylinder and said at least one assembly is a sliding connection.

7. The device for driving flaps according to claim 1, wherein the connection between said at least one cylinder rod of the longitudinal drive cylinder and said at least one assembly is a pivot connection of vertical axis.

8. The device for driving flaps according to claim 1, wherein the connection between said at least one connecting rod and said at least one assembly is a sliding connection.

9. The device for driving flaps according to claim 1, wherein the connection between said at least one connecting rod and said at least one assembly is a pivot connection of vertical axis.

10. The device for driving flaps according to claim 1, wherein said at least one cylinder rod of the longitudinal drive cylinder is connected to said at least one assembly by at least one moveable carriage.

11. The device for driving flaps according to claim 1, wherein said at least one connecting rod is connected to said at least one assembly by at least one moveable carriage.

12. The device for driving flaps according to claim 1, wherein said at least one control ring substantially extends over the entire circumference of the nacelle.

13. The device for driving flaps according to claim 1, wherein said at least one control ring comprises a plurality of independent sections moveable in rotation along the circumference of the nacelle during the activation of the driving means.

14. The device for driving flaps according to claim 1, wherein said at least one assembly of which an end is secured to a guiding pin shaped to translate in a hole inscribed on an outer face of said at least one control ring.

15. The device for driving flaps according to claim 1, wherein said at least one assembly comprises first and second holes, said at least one cylinder rod being secured at an end to a guiding pin shaped to translate in the first hole, and the second hole receiving a guiding pin secured to an end of said at least one connecting rod.

16. A thrust reverser for a nacelle of a turbojet engine of an aircraft comprising at least one downstream cowl comprising in downstream at least one adaptive nozzle comprising at least one flap alternatively moveable between a retracted position and a deployed position, wherein said at least one downstream cowl comprises at least one device driving said at least one flap of the nozzle according to claim 1.

17. A nacelle of a turbojet engine of an aircraft comprising at least one thrust reverser according to claim 16.
